(19) United States
(12) Patent Application Publication
(10) Pub. No.: US 2008/0221983 A1
(43) Pub. Date: Sep. 11, 2008

(54) Network information distribution system and a method of advertising and search for supply and demand of products/goods/services in any geographical location

(76) Inventors: Siarhei Ausiannik, Minsk (BY); Vitali Kalasouski, Minsk (BY)

Correspondence Address: Siarhei Ausiannik, Pobediteley Prospekt 39/268, Minsk, 220035, BY

(21) Appl. No.: 11/715,059

(22) Filed: Mar. 6, 2007

(51) Int. Cl. G06Q 30/00

(52) U.S. Cl. 705/14; 707/10

(57) ABSTRACT

The proposed system and method embodiments allow placing advertisements and searching for items within a network (Internet, intranets, etc.), particularly encompass server advertiser and consumer programs associated with database means, provide for multi-language, multi-currency, multi-items entry, multi-location, geographical-category and catalog-category resolution, multi-parameters setting, and other types of support. The method may include combinations of a normalized category suggestion, user feedback category/listing suggestion, custom-made category creation, and regular keyword search modes for placement and search phases. The user feedback suggestion is provided by the system memorizing previous user-approved linkages between entered keyterms and respective categories or listings, and then proposing them to current users entering similar keyterms. The normalized category suggestion is generated by the system storing records preferably based on a normalized data hierarchy. The custom-made categories may be converted into relational, object-relational, or object-oriented database records. Such modes facilitate placement and search for users of different skills levels.

### TECHNICAL FIELD

The present invention relates to information distribution systems and methods, specifically to systems and methods of advertising goods, services, and other products and search therefor using computer networks such as the Internet, intranets, and the like.

### BACKGROUND OF THE INVENTION

A Local Search Report published on the Internet in May 2004 by the Advanced Interactive Media Group and the Neil Budde Group (http://www.classifiedintelligence.com/downloads/?id=33dd3de1f090c57df51a627f378508d9) stated that “newspapers, yellow pages and local broadcasters . . . all share in the local advertising pie, estimated at $22 billion last year in the United States alone.” On the other hand, Louise Story and Eric Phanner in their article “For the Future of Web Ads, Look to Britain” published on Dec. 4, 2006 in Times Digest.® (from The New York Times.®) mentioned that “Online advertising is racing ahead in Britain, growing at a roughly 40 percent annual rate, and is expected to account for as much as 14 percent of overall ad spending this year, according to media buying agencies.” It is very likely that other countries will follow suit.

According to the prognosis of Jakob Nielsen published on http://www.useit.com/alertbox/internet-growth.html on Dec. 19, 2005: “The Internet is growing at an annualized rate of 18% and now has one billion users. A second billion users will follow in the next ten years, bringing a dramatic change in the worldwide usability needs.” He also stated “ . . . e-commerce sales will at least double from their current level when more of the current billion users start shopping online.”

The same article further says: “By 2015, Americans will be less than 15% of Internet users and will likely account for about one-third its value (Americans typically spend more than other users). The fact that two-thirds of Internet revenues will come from other countries highlights the growing importance of international usability. Unfortunately, few companies currently do user testing abroad, and fewer still have a truly robust internationalization strategy. Sooner or later, local options will increase and overseas users will stop using sites that don't meet their requirements.” In light of such trend, it becomes increasingly important to develop effective systems and methods for international advertising on the Internet.

Nowadays, the main Internet search giant Google (according to some estimates, holding more than 45% of all searches) is also the world leader in online advertising. Its recent patent application publication 20050216335 (by Andrew Fikes, et al) as of Sep. 29, 2005 discloses a system and method for providing on-line user-assisted Web-based advertising. That application teaches how to create an advertisement and an advertising creative from user inputs and data stored in the system, wherein the advertisement is hosted as a Web page, and the creative (typically having a link to the advertisement page) is placed on one or more targeted Web pages. Therefore such systems and methods are aimed to “Web content by attaching creatives” to other Web sites, wherefrom the advertiser hopes to attract users to his/her site.

In real practice that system does not provide a true choice for a needed item search in particular geographic localities or in normalized catalog categories. Though it provides a limited possibility to place an ad targeted at a particular country or in particular language, but different language searchers won't be able to read such ad. Thus, to reach those searchers, the advertiser has to place a plurality of ads in all desirable languages that often cannot be feasible and affordable for him. Furthermore, it sometimes becomes heavy even for large advertisers. For instance: “Some Google advertisers cutting spending. Keyword inflation, low conversion rates sending merchants elsewhere” By Ben Charny, MarketWatch, Last Update: 10:58 PM ET Jan. 3, 2007 (published on http://www.marketwatch.com/news/story/google-advertisers-cutting-spending-keyword/story.aspx?guid=%7bE9B9CEA8-EA47-48C6-A91F-69F53F018AE2%7d&print=true&dist=printTop) particularly says: “While losing a few million here or there may not be enough to impact Google's business which generated more than $7 billion in sales last year those interviewed for this story say their sentiment is not unusual among Google advertisers of their size. If enough of those companies curtail their Google spending, it could begin to depress the company's annual revenue growth rate, which is already expected to slow to 47% this year from 80% in 2006.”

Another aspect of the online advertising is raised in an article of Jakob Nielsen “Advertising on product pages. Amazon spends about two inches of each product page advertising other websites. Although this generates revenue, the average e-commerce site should be ashamed if it can't make far more money selling to a hot lead who's already investigating one of its own products. Amazon's position as the default place to buy books is so strong that it can afford to send shoppers off to other sites, knowing they'll return later and buy the book anyway. You can't make the same assumption. Sell to your prospects, rather than throw them away.” (http://www.useit.com/alertbox/20050725.html, dated Jul. 25, 2005). This reflects a trend for search sites to facilitate sales, not only advertise them.

In another article of Jakob Nielsen (http://www.useit.com/alertbox/b2b.html) published as of Jun. 1, 2006, the author summarizes: “User testing shows that business-to-business websites have substantially lower usability than mainstream consumer sites. If they want to convert more prospects into leads, B2B sites should follow more guidelines and make it easier for prospects to research their offerings.” In the other words, commercial sites should develop own tools to facilitate searches and research for users to advance their business.

Such an approach is taken in a recent patent U.S. Pat. No. 7,050,990 by Lester Chu et al issued to Verizon Directories Corp. on May 23, 2006. That patent is hereby entirely incorporated by reference. It describes a system and method that focuses on information exchange between sellers and buyers. In particular, it teaches, “Buyers identify potential sources for goods and services that are desirable to the buyer. Buyers can focus their access to listings of seller information by identifying desirable attributes, including but not limited to: geography attributes relating to the location(s) of the seller; and category attributes relating to the various categories of offerings that interest to the buyer.”

That patent analyses shortcomings of traditional telephone books having substantial geographical and category-structure limitations inherent to static information sources. For example, they lack a direct feedback mechanism and statistics, which prevents enhancing communication between publishers, providers, and consumers. Such deficiencies substantially hamper the implementation of a pricing mechanism, e.g. charging advertisers on a “per-hit” or per transaction basis or for automatic placement within a well-defined geographical region, preferential placement in the listings based on objective criteria (for instance, statistics, hits, e-mails) to encourage advertising by providers, etc.

It also recognizes that some phone books limitations “are addressed by various information technology tools such as search engines and other mechanisms that utilize the World Wide Web, or similar networks.” On the other hand, “The use of search engines . . . too often results in ‘information overflow’ for the user, as well as the providing of so-called ‘false positives’.” For instance, a search term ‘restaurant’ may return “a voluminous number of ‘restaurant’ references having nothing to do with actual restaurants that are open for business and seeking customers.” The “bid-based” approaches also have their downsides: “local providers are bidding against national providers. Providers within a specialized sub-category . . . are bidding against more general providers.”

U.S. Pat. No. 7,050,990 particularly teaches implementing “the organization of various provider listings into ‘groups’ based on geography, category, fee type (such as fixed fee approaches or bid-based approaches), and other distinctions.” Accordingly, it proposes a ‘normalized’ category hierarchy, “allowing the system to make finely tuned distinctions based on subtle attribute differences. The use of predefined data hierarchies can provide the best possible universe of results and minimizing the loss of relevant results based merely on differences in nomenclature.”

It is however apparent that such a hierarchy category system supposes a consumer to be familiar with the hierarchy, which sometimes is not the case. What if the consumer knows exactly a list of items of interest, but is not familiar with a complicated hierarchy system? He/she would probably be compelled to investigate the hierarchy until finding the right routes to the desirable items, or to give up. Unfortunately, U.S. Pat. No. 7,050,990 gives no clue how to increase chances of the finding, or minimize the search time for such consumer, “based merely on differences in nomenclature”. Nor does that system provide means for international search, which might allow the consumer to find the required items faster, or at less expenses, or at more favorable terms and conditions. Also, it does not offer any noticeable support for users of different languages, different currencies, or for advanced business users/analysts, who need to research arrays of various items in desirable price ranges.

Another patent U.S. Pat. No. 7,089,194, hereby entirely incorporated by reference, further explores ways of advertisement delivery to the consumer: “As a user of the client browses the World Wide Web, the material that is downloaded to the client constitutes a datastream. At some location during the routing of the datastream, either on the server or at the client, the datastream is scanned to generate a list of keywords that are present within the datastream. The datastream may be analyzed in real-time or cached and analyzed on a delayed basis. The generated list of keywords represents a summary of the content that appears to be the focus of interest of the user. The keywords are compared against a database of advertisements, and the server selects an advertisement that matches the user's area of interest in comparison to the analysis of the user's browsing history. The selected advertisement is then inserted into the datastream to be routed to the client.”

Therefore, U.S. Pat. No. 7,089,194 is an attempt to use a user's interaction with the Web in the form of an initial download for extracting information believed to be most relevant to the user's need. That patent is also an example of utilization of the interaction to facilitate the finding of database items potentially interesting for the user, which he/she even might be not aware about. However, the initial download is not always the right indicator to predict the true purpose of a following search of the user, since the user may change his/her mind and start searching for something completely different.

Several millions of new businesses start during a year, and nearly the same number disappear. Small local businesses, such as a family flower shop on the corner, often have no sufficient resources to establish a structure and staff for Internet sales and necessary advertisement for survival and growth. Such local businesses of many geographical localities and languages would likely be interested to have a general online platform (system) to present their goods/services/other products (collectively ‘products’) in an inexpensive way. Obviously, a majority of such local businesses cannot compete with large advertisers, which does not necessarily mean that their products cannot compete in price or in quality with those offered by the “big guys”.

A desirable system might propose an equal access opportunity to all its participating advertisers by arranging a response to a consumer search in the form of advertising listings, sorted and positioned according, for example, to prices of the searched product, but not according to the amount spent by the advertiser to place his/her/its ad listing. Thus, it would be in the best interest of the local business and consumer communities to have such an online choice.

Such a system might also propose different ways to optimize user search, offering a traditional (regular) keyword search, a normalized category search, and other types of searches in various combinations for users of different levels of skills.

A lot of the products would be of a special interest to those Internet users-consumers, who know exact names, brands, models, and types (for instance, recommended by friends or relatives, or other trustful sources) of the products they are looking for. For business users-consumers, it might be indispensable to have a tool allowing to submit their list of searched items (e.g. copied from a table in MS Excell.®) in “one shot” into the system, and obtain a plurality of responses each dedicated to a particular item from the list. For advertisers, it would be very convenient to utilize such a tool for placing a plurality of listings into the system, and practically to create a catalog of items for sale in several minutes.

### SUMMARY OF THE INVENTION

It is therefore one aim of the invention to overcome one or more of the aforesaid shortcomings of the existing systems and methods of advertising. What is desired is a network information distribution system (NIDS) utilizing at least a portion of predetermined media such as the Internet, intranets, etc., and a method for providing an equal access opportunity for any advertiser (typically, a seller) to place specific information on products/goods/services), offered for sale (or sought for purchase by a purchaser) into the system in the form of advertisement listings preferably in a specified catalog, category and subcategory, language, for a specified geographical location, with specified parameters; as well as providing an opportunity for a consumer (typically, a buyer) to submit a search request for a desirable item (or a collection of items) in different ways depending on the consumer's skills, get a suggestion/correction by the system, if necessary, conduct the search throughout the system's advertisement listings, and obtain a response list including found listings expected to substantially contain detail information on the item (collection of items) corresponding to the consumer's request, wherein the list is preferably sorted and arranged by price; the request can be submitted in at least one of a predetermined list of languages; and the response can be produced in any desirable language from a predetermined list of languages.

Another aim of the invention is to provide additional features of the NIDS, such as: a convenient set of GUIs presenting geographic information in the system; a combined “keyword—user feedback suggested listings—normalized category” search; a combined “normalized category—user feedback suggested category—custom-made category” placement of ads; a “complete line editor” for a multiple items request; a possibility of a consumer to make a “request to multiple advertisers” for required items; maintaining a “microsite” in the system and recommendation links thereon; etc.

Other aims of the invention will become apparent from a consideration of the drawings, ensuing description, and claims as hereinafter related.

The proposed system and method embodiments allow placing advertisements and searching for items within a network (Internet, intranets, etc.), particularly encompass server advertiser and consumer programs associated with database means, provide for multi-language, multi-currency, multi-items entry, multi-location, geographical-category and catalog-category resolution, multi-parameters setting, and other types of support. The method may include combinations of a normalized category suggestion, user feedback suggestion, custom-made category creation, and regular keyword search modes for placement and search phases. The user feedback suggestion is provided by the system memorizing previous user-approved linkages between entered keyterms and respective categories or listings, and then proposing them to current users entering similar keyterms. The normalized category suggestion is generated by the system storing records based on a normalized data hierarchy. The custom-made categories may be converted into relational, object-relational, or object-oriented database records. Such modes facilitate placement and search for users of different skill levels.

### BRIEF DESCRIPTION OF THE DRAWINGS

FIG. 1 is a block diagram illustrating an embodiment of the network information distribution system (NIDS) with its basic units, according to a preferred embodiment of the present invention.

FIG. 2 is a computer screen snapshot, illustrating a GUI for a client consumer interface, according to a NIDS embodiment.

FIG. 3 is a computer screen snapshot, illustrating a GUI for a client consumer interface, according to a NIDS embodiment.

FIG. 4 is a computer screen snapshot, illustrating a GUI for a client consumer interface, according to a NIDS embodiment.

FIG. 5 is a computer screen snapshot, illustrating a GUI for a client consumer interface, according to a NIDS embodiment.

FIG. 6 is a computer screen snapshot, illustrating a GUI for a client consumer interface, according to a NIDS embodiment.

FIG. 7 is a computer screen snapshot, illustrating a GUI for a client consumer interface, according to a NIDS embodiment.

FIG. 8 is a computer screen snapshot, illustrating a GUI for a client advertiser interface, according to a NIDS embodiment.

FIG. 9 is a computer screen snapshot, illustrating a GUI for a client advertiser interface, according to a NIDS embodiment.

FIG. 10 is a computer screen snapshot, illustrating a GUI for a client advertiser interface using a normalized category hierarchy, according to a NIDS embodiment.

FIG. 11 is a computer screen snapshot, illustrating a GUI for a client advertiser interface using a complete line editor, according to a NIDS embodiment.

FIG. 12 is a flowchart illustrating a combination of a regular keyword search, a user feedback suggested listing search, and a normalized category search, according to a NIDS embodiment.

FIG. 13 is a diagram illustrating a sample normalized category hierarchy, according to a NIDS embodiment.

FIG. 14 is a flowchart illustrating a sample normalized category search, made for the hierarchy shown on FIG. 13, according to a NIDS embodiment.

FIG. 15 is a computer screen snapshot, illustrating a text editor GUI for creating a microsite, implemented for a client advertiser interface, according to a NIDS embodiment.

FIG. 16 is a flowchart illustrating a structure and processing of a server advertising program, according to a NIDS embodiment.

FIG. 17 is a flowchart illustrating a structure and processing of a server customer program, according to a NIDS embodiment.

FIG. 18A is a computer screen snapshot, illustrating a GUI for the client advertiser interface using the Harmonized System of categories, according to a NIDS embodiment.

FIG. 18B is a computer screen snapshot, illustrating a setting parameters GUI for the client advertiser interface, according to the NIDS embodiment referred to on FIG. 18A.

FIG. 18C is a computer screen snapshot, illustrating a setting parameters GUI for the client advertiser interface, according to the NIDS embodiment referred to on FIG. 18A.

FIG. 19 is a flowchart illustrating a combination of normalized category—user feedback suggested category—custom-made category ad placement structures and processing, according to a NIDS embodiment.

Similar reference numerals on the drawings generally refer to the same or similar elements on different figures. A newly introduced numeral in the description is enclosed into parentheses.

### DESCRIPTION OF PREFERRED EMBODIMENTS OF THE PRESENT INVENTION

While the invention may be susceptible to embodiment in different forms, there are shown in the drawings, and will be described in detail herein, specific embodiments of the present invention, with the understanding that the present disclosure is to be considered an exemplification of the principles of the invention, and is not intended to limit the invention to that as illustrated and described herein.

The System Structure

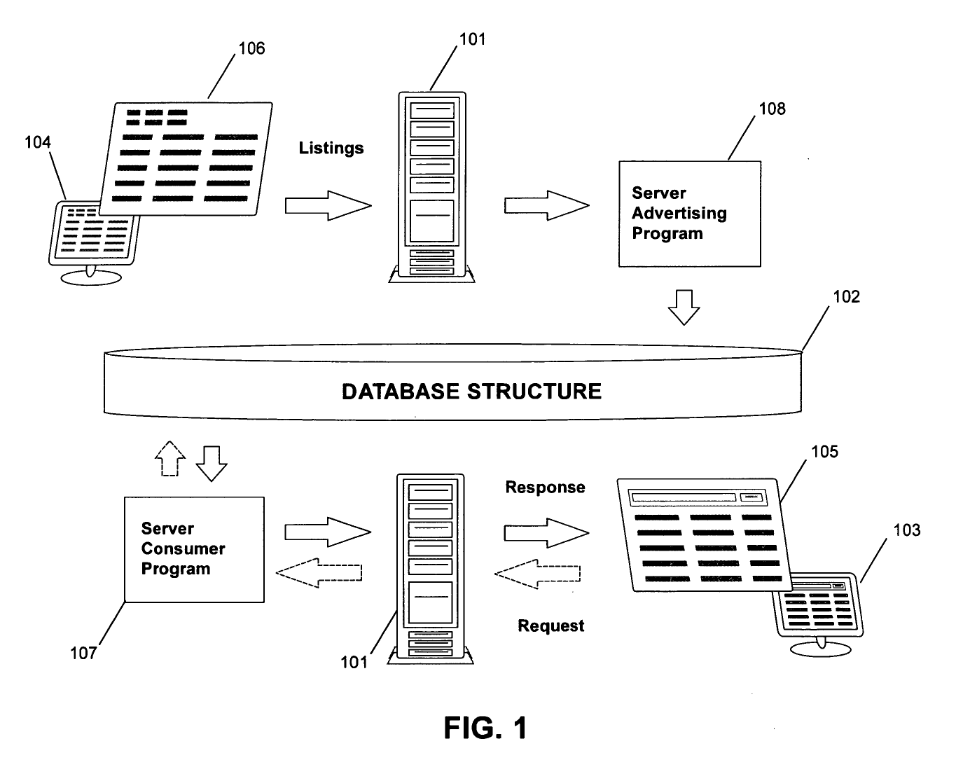

Referring to a preferred embodiment, illustrated on FIG. 1, the inventive NIDS comprises: a server means (101) (typically including at least one appropriate workstation with predetermined processor means and a predetermined operating system, a Web server, an SQL server, administrator software, etc., configured to provide required functionality), providing network server support and suitable medium (such as the Internet, intranets, etc.); database means (102) associated with the server means (typically a conventional database structure capable to store and manage data in the form of records); server advertising program means (108) associated with the server means (substantially software configured to provide required functionality); server consumer program means (107) associated with the server means (substantially software configured to provide required functionality, including a search engine); at least one client advertiser access device (104) (may be a desk-top, lap-top, mainframe, mini computers, or a palm computer, PDA, cellular telephone, or the like, each including a predetermined processor means and a predetermined operating system) capable to communicate with the server means usually via conventional network means; at least one client advertiser interface (106) (typically a browser substantially containing graphic user interfaces—GUI, configured to provide required advertiser functionality) substantially residing in client advertiser access device 104 and capable to communicate with server advertising program means 108; at least one client consumer access device (103) (may be similar to the client advertiser access device) capable to communicate with the server means usually via conventional network means (such as the Internet, intranets, or similar media); at least one client consumer interface (105) (typically a browser substantially containing graphic user interfaces—GUIs, configured to provide required consumer functionality) substantially residing in client consumer access device 103 and capable to communicate with server consumer program means 107. A client advertiser access device may typically operate as a client consumer access device and vice versa.

The Server Advertising Program

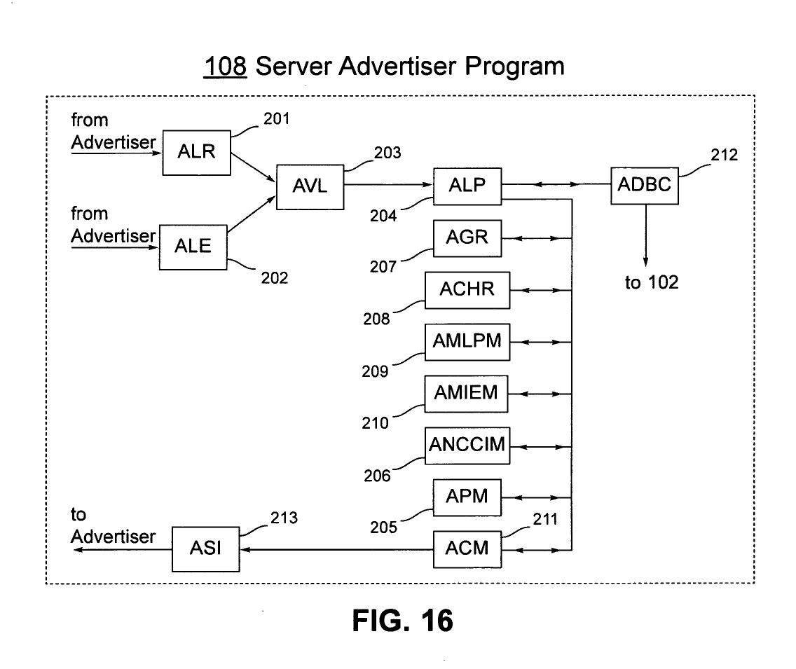

In a preferred embodiment, shown on FIG. 16, server advertising program means 108 may comprise means for: receiving an advertiser's listing (ALR) (201); editing the listing (ALE) (202); validating the listing (ALV—sometimes connected to the administrator software) (203); logic processing (ALP) (204); means for database connection (ADBC) (212); resolution on the geographical hierarchy (AGR) (207); resolution on the category hierarchy (ACHR) (208); multi-language processing (AMLPM) (209) that may include different language resolution modules; multiple items entry (AMIEM) (210); national currencies conversion information (ANCCIM) (206); payment (APM—besides conventional credit card payment systems, other payment means can be implemented depending on the country of the advertiser or consumer, such as intermediate credit card system, e.g. “Assist” in Russia, a debit system, e.g. “Internet Money”) (205), etc. Some embodiments may further comprise advertiser correction means (ACM, e.g. suggested spelling, or the correct geographic locality name to be used, and so on) (211), and advertiser correction sending means (ACS) (213).

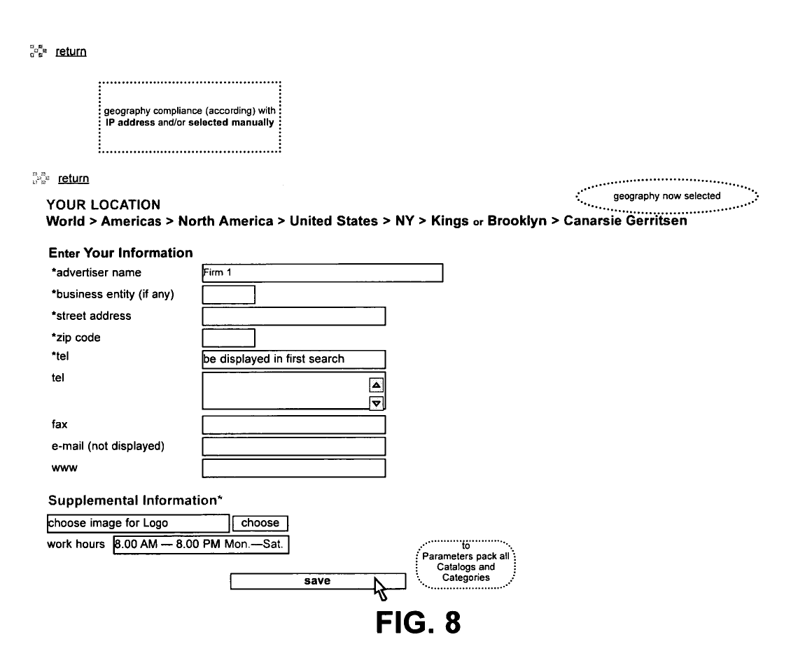

Server advertising program means 108 provide a specific functionality to place an advertisement listing into the NIDS which is a first (placement) phase of the inventive method. The advertisement listing should include as detail information as possible on the advertiser and/or seller requisites (typically a company's name, a full name of a contact person, address, telephone, fax, e-mail, website, etc.); a title; a short and full item(s) description; item(s) conditions; image(s) of the item(s); a catalog (category within a catalog); a retail/wholesale/demand/private ad identification (typically the highest level of a category hierarchy); price range(s); item(s) location(s); availability timeframes; payment (financing) terms; shipping info; custom duties; sanitation info, etc. Examples of client advertiser GUIs for advertiser listing entry and choosing parameters forms are illustrated on FIG. 8, 9, 10, 11 described in detail herein below. Typically, server advertising program means 108 include a functionality to create an account for the advertiser including an account name and password (not illustrated) upon an initial registration, and is associated with a billing system (not illustrated).

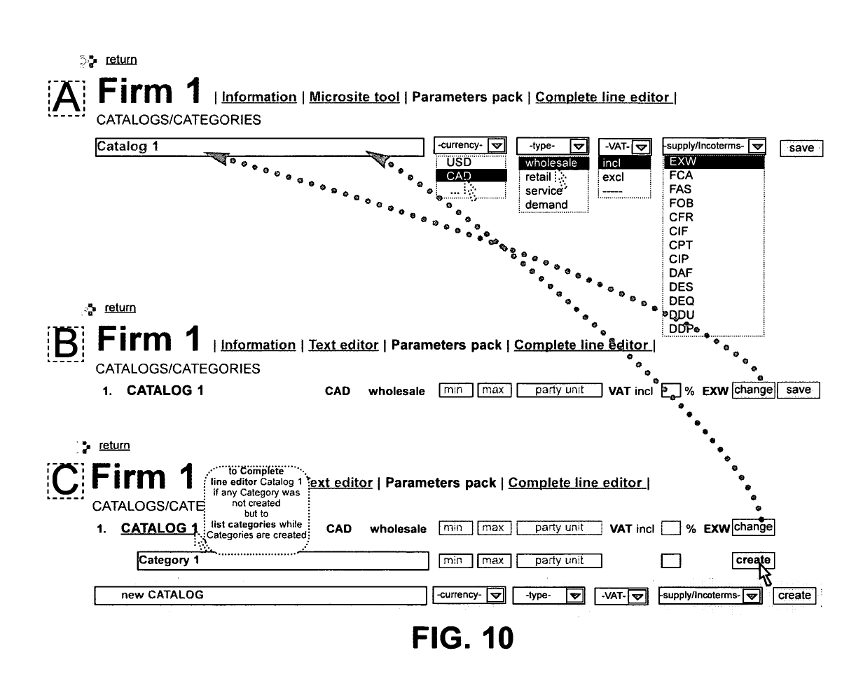

In some embodiments, the advertiser is generally required to create his own custom-made catalog or use one that was previously created, and create his own custom-made categories. The catalog may be transformed into a relational database table(s), if possible, or an object-relational, or object oriented, or another non-relational database structure, or other suitable conventional data structures can be utilized. Then the catalog can be used by users-consumers to search for items. This can be done typically if the NIDS is intended for non-sophisticated users that may be deterred from using a system with a complicated normalized category hierarchy. An exemplary process of creation of such catalogs and categories is reflected on FIG. 10, 11 and described below in more detail.

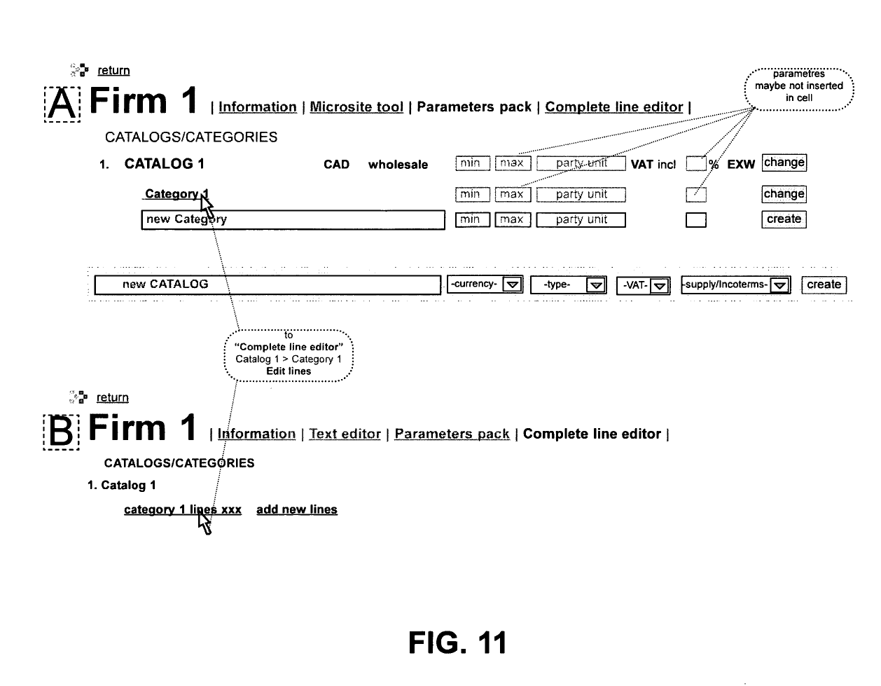

Some preferred NIDS embodiments may comprise AMIEM 210, including a GUI for a complete line editor, whose exemplary GUI representation is depicted on FIG. 11. It allows the advertiser to copy at least a portion of data contained in a table (in the formats of MS Office Excel.®, Open Office Calc.®, .doc, .txt, .rtf., and similar) from the table into a text area of client advertiser interface 106 (FIG. 1). Such copying may be accomplished through the use of conventional GUI functions Copy—Paste (for instance: Ctrl-C and Ctrl-V, or using the right mouse clicks, etc.). If different table columns have an equal number of elements, the complete line editor produces the corresponding number of strings, and special symbols dividing the columns (e.g. as in MS Office Excel.®) will be transformed into regular space symbols in the text area. Server advertising program means 108 will then process the entered data and insert corresponding listing records in database 102. The same result can be achieved by using not only the complete line editor, but also another similar tool performing the same function.

In such a way, the advertiser would be able to form his/her own online catalog consisting of thousands of listings within a few minutes. In some embodiments, such a catalog can be indexed during a user's search in the real time mode.

Advertiser Placement Modes

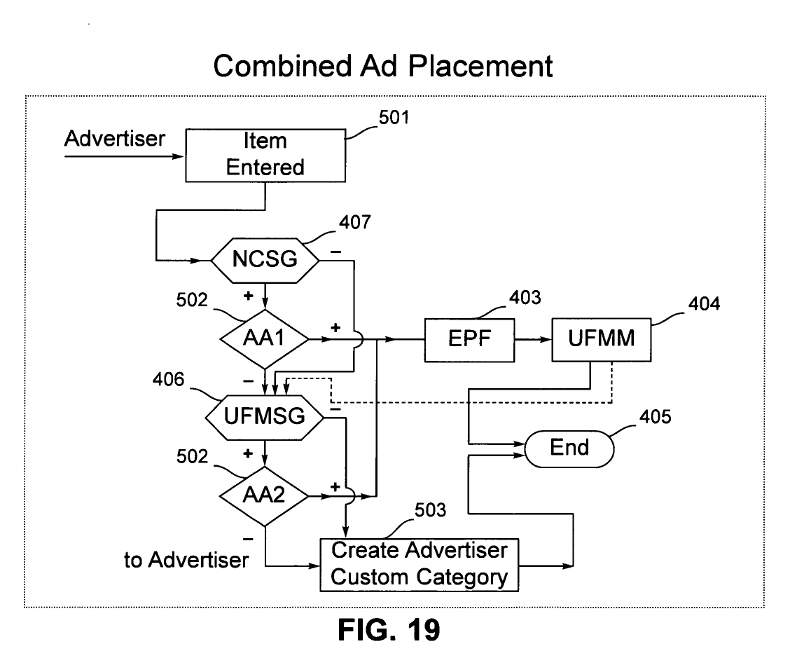

In other NIDS embodiments, the advertiser may be able to use not only custom-made categories, but also various strategies and techniques utilizing a normalized category hierarchy (generally built into at least a portion of database means 102) mode (e.g. the Universal Harmonized System Codes), and/or a user feedback category suggestion mode (discussed further). For this purpose, the aforementioned ACHR 208 associated with ALP 204 (depicted on FIG. 16) and other necessary conventional means and utilities (not shown) can be implemented using several modules, as shown on FIG. 19.

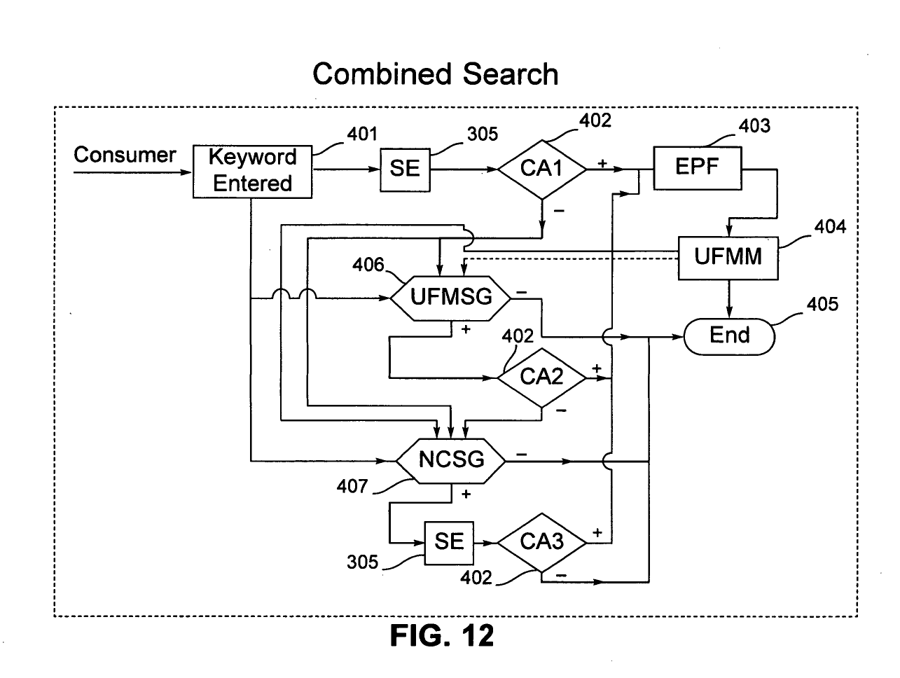

In a preferred embodiment, the advertiser submits keyterms (as she believed, adequately representing, e.g. the title of the item(s) to be listed), further received by ALR 201 (FIG. 16). A portion of ALR 201 is represented on FIG. 19 as an “Item Entered” block (501). A normalized category suggestion generator (NCSG) (407) illustrated on FIG. 19 (and also on FIG. 12) analyses the keyterms and generates a suggested category/subcategory for placement of the item(s). NCSG 407 uses a database structure (generally kept in database means 102) and adapted to a normalized category hierarchy. Thus, in general, NCSG 407 is substantially connected to database means 102 (the connection is not shown).

NCSG 407 may suggest elevating the subcategory level (e.g. one step towards less specialization), and so on, until an approval from the advertiser is obtained, or a certain scope of categories or the entire database would have been considered.

In case NCSG 407 has no suggestion, or a suggested category doesn't result in an advertiser's approval for placement of the item, the program may use a memorized suggestion mode (see below).

FIG. 19 illustrates an embodiment comprising mechanisms, which combine the normalized category suggestions mode and a user feedback memory module (UFMM) (404) (for the user feedback memory suggestion mode), asking the user (advertiser) if he/she is satisfied with the suggested category result via an advertiser approval (AA1) interface (502).

An enter positive feedback (EPF) block (403) registers the user's positive answer and saves respective information via UFMM 404. In such a case, the NIDS may keep the entered keywords and the approved category in memory (e.g. it can be kept as an index to corresponding database records or otherwise). The memorized category in response to the entered keyterms is further used as a suggestion produced by a UFM suggestion generator (UFMSG) (406) for another user (advertiser) entering similar keyterms, which is conditionally illustrated by a dashed line on FIG. 19.

If the answer at AA1 502 is negative, meaning that no approval has been obtained from the advertiser, a suggestion can be generated by UFMSG 406, which is then presented to the advertiser at another advertiser approval (AA2) interface 502 (interfaces AA1 and AA2 502 may be joined in one module that is not illustrated). A positive answer will be processed by EPF 403, as indicated previously.

A negative answer, as well as a “no UFMSG suggestion” (where no suggestion may be generated anymore) will transfer the program to a create advertiser custom category block (503) (a custom-made category creation mode), schematically shown on FIG. 19, whose exemplary GUI is represented on FIG. 10. When a custom-made category has been created by the advertiser, the program may be conditionally ended at an end (405), as illustrated on FIG. 19.

The custom-made catalog and categories will generally not comply with a normalized category hierarchy (unless additional conversion means are provided) and will be stored separate from the normalized items, for instance, using a non-relational (e.g. object-oriented) database structure. UFFM 404 and EPF 403 can be written in an object-oriented programming language (such as Java, etc.) and conventionally connected to database means 102. A consumer user, searching for such a “non-normalized” item, most likely might be able to find it through a regular keyword search, discussed below.

Other embodiments may deploy a different sequence of the described modes, e.g. the UFM category suggestion mode might be tried first, and the normalized category suggestion mode might be the second, followed by the custom-made category creation, or otherwise. A single mode or a combination of two modes from the aforementioned three modes may also be implemented in some embodiments. In certain embodiments the advertiser may have a choice to order an additional service of placing his/her advertisements by the system administration.

Some embodiments may, however, include means for analyzing and “normalizing” the “non-normalized” items, i.e. conversion of them into a data structure capable to be adapted to a normalized category hierarchy. Different semantic-aware approaches might be utilized. One of them is described in “Semantic Breakthrough” by David Baum (Oracle Magazine—May/June 2006, p. 42-46). A new technology called “The Semantic Web” puts HTML data into a machine-readable format, enabling a computer to aggregate it and understand their relationships, which is accomplished with XML and data-language standards such as Resource Description Framework (RDF) and Ontology Web Language (OWL)—both are WWW Consortium standards. Using the standards and descriptors, Web developers are enabled to add layers of meaning to Web documents, i.e. to supply a framework for defining data linkage and for expressing the intended relationships. The Semantic Web provides a customized lexicon (ontology) for delivering relevant information to people doing casual searches. The ontologies coded with RDF can be understandable to electronic search means. The article names Oracle Database 10g Release 2 as a means for creating semantically enabled databases in conjunction with development tools supplied by a company called Cerebra. Catalogs, categories, and listing parameters processed in such a manner, may be eventually memorized in a relational database. Other embodiments may not use a normalized category hierarchy at all. This may partially change the structure of the server advertising program means or the server consumer program means accordingly.

Basic Category Creation Features and Steps of the Ad Placement Phase of Inventive Method

As mentioned above, in some embodiments, the advertiser is generally required to create his own custom-made catalog or use one that was previously created, and create his own custom-made categories with predetermined parameters. The catalog may be transformed into a relational database table(s) if possible; or a non-relational (e.g. object-oriented, etc.) database structure or other suitable conventional data structures can be utilized for storage of the catalog, categories, and listing parameters.

In other NIDS embodiments, the advertiser may be able to use not only custom-made categories, but also various strategies and techniques preferably utilizing a normalized category hierarchy (generally built into database means 102) mode (e.g. deploying the Universal Harmonized System Codes), a user feedback category suggestion mode, and a custom-made category creation mode.

The advertiser submits keywords (as believed, adequately representing, e.g. the title of the item(s) to be listed), further received by the NIDS, which analyses the keywords and generates a suggested normalized category/subcategory for placement of the item(s). If the suggested category is not approved by the advertiser, the NIDS may suggest elevating the category level (e.g. one step towards a lower specialization or higher generalization), and so on, until an approval from the advertiser is obtained, or a certain scope of categories or the entire normalized portion of the database would have been considered by the advertiser.

In case the NIDS has no suggestion, or the suggested categories don't result in an advertiser's approval for placement of the item, the system may switch to a user feedback category suggestion mode, as discussed below. If the user feedback category suggestion mode does not result in the advertiser's approval, the advertiser may switch to a custom-made category creation mode, or, in some embodiments order the ad placement by the system administration (no illustrated).

For example, let's consider an embodiment of the method that combines the normalized category suggestions mode and the user feedback category suggestion mode. In response to entered keywords, the NIDS provides the advertiser user with a suggested normalized category, and asks if he/she is satisfied with this category, i.e. for his/her first approval. The NIDS will provide the user with normalized suggestions elevating the generalization of the category levels until it obtains the first approval, or the entire normalized database portion has been considered. Optionally, the advertiser may stop the process, and switch to the custom-made category creation mode, disclosed herein further.

The user's first approval triggers saving the entered keywords and a link to the approved normalized category in memory in case the entered keywords do not exactly match those already kept in memory for the normalized category suggestion provided to the user. The memorized entered keywords are further used as a normalized category suggestion produced by the NIDS for another user (advertiser or consumer) entering similar keywords.

If the first approval has not been obtained from the advertiser, the NIDS switches to the user feedback category suggestion mode. In the user feedback category suggestion mode, a feedback suggestion can be generated by the NIDS from a non-normalized portion of memory (in case the NIDS has no conversion means) storing previously entered custom-made catalogs and categories, which feedback suggestion of the catalogs and categories is then presented to the advertiser for a second approval. The second approval triggers saving the entered keywords (they are similar to the keyterms of the approved feedback suggestion already kept in memory, but not exactly the same), and a link to the approved category in the non-normalized portion of memory to further provide a feedback suggestion to subsequent advertiser (and, in some embodiments, searching consumer) users.

If the second approval has not been obtained from the advertiser, this will transfer the program to the custom-made category creation mode. When a custom-made catalog or category has been created by the advertiser, it will be kept in the non-normalized portion of memory (in case the NIDS has no conversion means) with a link to the entered keywords to further provide the custom-made suggestion to subsequent advertiser (and in some embodiments to consumer) users.

As noted above, other embodiments of the method may deploy a different sequence of the described modes, e.g. the user feedback category suggestion mode might be tried first, and the normalized category suggestion mode might be the second, followed by the custom-made category creation, or otherwise. A single mode or a combination of two modes from the aforementioned three modes may also be implemented in some embodiments.

The placement of ads will also involve setting geographical localities and parameters of the advertisement listings. A geographical category hierarchy (preferably a normalized hierarchy) is adapted by a portion of the database means. The geographic resolution means (within the server advertising program means connected to the database means) provide processing of advertiser items placement in different world locations through GUI forms filled out and submitted by the advertiser (discussed below).

Similarly, the advertiser completes other GUI forms with his own requisites, and with specific item parameters to be listed as discussed in GUI examples below. During the placement, the advertiser can set up the language of the GUI forms, the lot size, the currency and payment options to be used for possible sales, as well as taxes and other parameters useful for information of a prospective buyer.

The Server Consumer Program

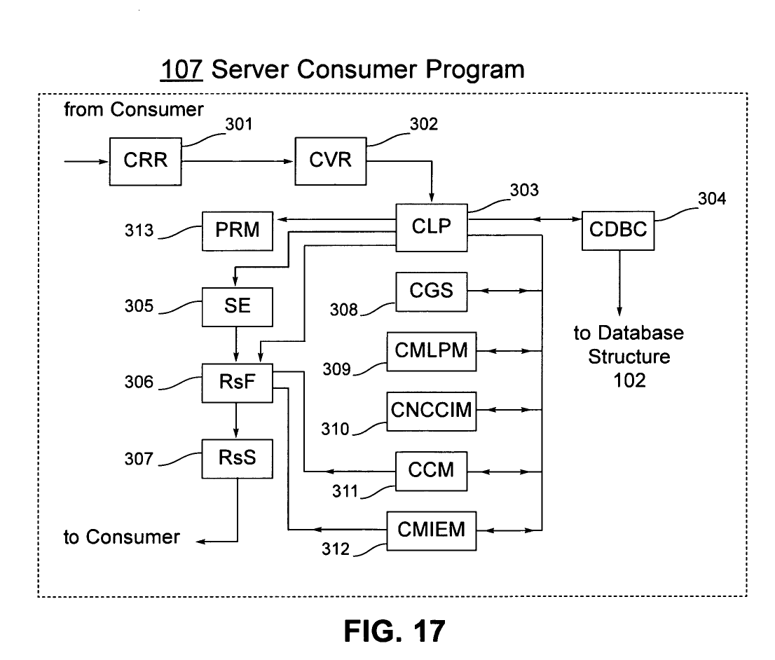

In a preferred embodiment of the NIDS, illustrated on FIG. 17, server consumer program means 107 provide a specific search functionality in a second (search) phase of the inventive method. The server consumer program means 107 comprise: a consumer request receiving means (CRR) (301) to collect data entered by a consumer; means for validating the request (CVR) (302), means for logic processing (CLP) (303); means for database connection (CDBC) (304); multiple language processing means (CMLPM—different language resolution modules can be deployed by the system, particularly implementing one of the Unicode standards) (309); a search engine (SE) (305); means for response formation (RsF) (306); means for response sending (RsS) (307); a customer national currencies conversion information means (CNCCIM) (310).

Preferred embodiments may further comprise consumer correction means (CCM, e.g. suggested spelling, suggested geographic locality name to be used, and so on) (311), shown on FIG. 17. Some embodiments may utilize one module for CNCCIM 310 and ANCCIM 206, and one module for ACM 211 and CCM 311.

Preferred NIDS embodiments comprise AMLPM 209 and CMLPM 309 (preferably implemented as one module) using the predetermined list of languages defined by Unicode standards (e.g., as shown on http://en.wikipedia.org/wiki/UTF-16). The NIDS should be able to recognize entered symbols and corresponding codes.

In some embodiments, SE 305 includes conventional keyword search mechanisms substantially resulting in finding exact matches to the key terms entered by the consumer. The search can be conducted through all database records entered by advertisers. Some embodiments may deploy conventional program means capable to recognize, for example, a 7-letter word, if the searcher enters only e.g. 3 or 4 letters.

As shown on FIG. 17, in preferred NIDS embodiments, a geographic locality switch (CGS) (308) can be implemented by server consumer program means 107 that allows to switch searching, e.g. from one country to another, or one region to another, while using the language preferred by the customer independent on the locality being searched.

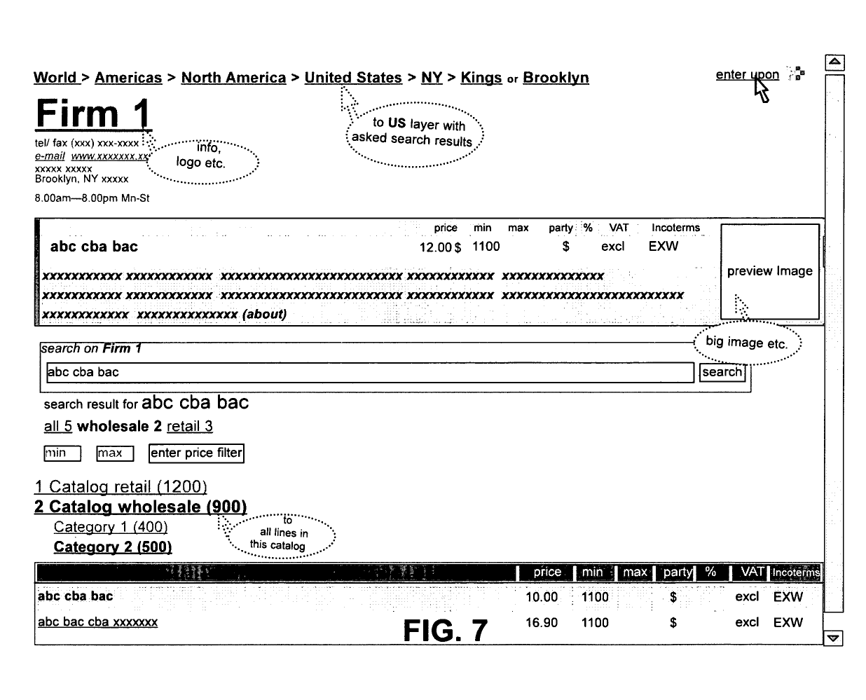

In a preferred NIDS embodiment, having obtained a response in the form of advertisement listings links, the consumer is able to chose a particular link (typically a title of the item, or its image, or sometimes a short description), and, by clicking on the link, to see a full description of the respective item(s), image(s), lot sizes, delivery terms (e.g. according to Incoterms), payment options, the advertiser's and/or seller's requisites, and, if needed, all catalogs and prices of the seller. An example of a GUI, providing such capabilities, is shown on FIG. 7.

In preferred embodiments, SE 305 (FIG. 17) may provide sorting the response listings resulted from the search by price and arrange the response listings in a corresponding (ascending or descending) order. Preferably SE 305 is associated with a price range module (PRM) (313), shown on FIG. 17, and functioning as a price filter, to facilitate finding desirable item(s) in a desirable price range. A GUI, depicted on FIG. 7, shows an “enter price filter” button, providing a consumer with such an option.

In preferred embodiments SE 305 may be associated with CNCCIM 310 (see FIG. 17), which would provide the consumer with corresponding information and assist in calculations to compare the prices of the found item(s), e.g. for different countries and regions wherein such item(s) is (are) located. One of the possibilities is to utilize existing national bank currency exchange rates relatively to a base currency of a particular country for a predetermined list of countries. The base currency is then used in CNCCIM 310, especially in conjunction with PRM 313. The above-mentioned ANCCIM 206 and CNCCIM 310 can be preferably deployed as one module.

CMIEM 312, including a complete line editor, similar to the one described for the server advertiser program means, may be implemented in some special embodiments for server consumer program means 107, which would enable the consumer to submit a search request for a plurality of items, and get a multiple response. The same result can be achieved by using not only the complete line editor, but another similar tool performing the same function. Supposedly such kind of search conducted, for example, through the existing Internet search engines (Google.com.®, Ask.com.®, etc.) could probably cause an “overheating” of the engines.

The NIDS of such a special embodiment, implementing this type of search, may use different conventional searching methods and means (e.g. keeping in RAM most frequent previous responses, etc.). This can be optionally implemented as a pay service (for example: subscription for interested users) or a free service, and would be indispensable for advanced commercial users (consumers) and analysts, who could save time working off-line (saving connection time for the server, that is an additional benefit to the NIDS) to prepare respective plural requests and submitting them in “one shot”. Some embodiments may deploy AMIEM 210 and CMIEM 312 as one module. Other embodiments may have a restriction on the number of items submitted through the complete line editor.

Preferred NIDS embodiments may comprise AMLPM 209 and CMLPM 309 as one module. The predetermined list of languages can be defined by a particular Unicode standard (e.g., one of them shown on http://en.wikipedia.org/wiki/UTF-16). The NIDS should be able to recognize entered symbols and corresponding codes.

Consumer Search Modes

Some embodiments of the NIDS may comprise search engines and additional mechanisms (not illustrated on FIG. 17), wherein different search strategies can be implemented. One of such strategies may suggest the consumer, in case she cannot find the exact match to the entered keyterms into a keyword entered block (401) by performing a conventional keyword search (a keyword search mode), to alter her request and start searching in a specific subcategory of a particular level (generally, any conventional normalized hierarchy adapted to a relational, or object-relational, or object-oriented structure, substantially built into database means 102, can be used), using the aforementioned normalized category suggestion generator (NCSG) 407 illustrated on FIG. 12 (also shown on FIG. 19, discussed above for the advertiser functionality).

If it doesn't result in finding the desirable item(s), NCSG 407 then suggests changing the subcategory level, for instance, to a less specialized one (e.g. one level up to the more general, or “parent” level), and so on, until a certain scope of categories or the entire database would have been searched.

Some embodiments (an example of which is illustrated on FIG. 12) may combine the traditional keyword search mode with the normalized category search suggestion mode and the user feedback listing suggestion mode (also called UFM mode, herein implemented with UFMM 404). In the UFM mode, the user (consumer) is asked at a consumer approval interface (CA1) 402 (similar to AA1 and AA2 402 discussed above) if he/she is satisfied with the search results. If the answer is “yes”, EPF 403 (similar to the one discussed for the advertiser modes above) registers the entered keywords and the response list, and saves them via UFMM 404 that will be kept in memory. It can be kept as an index to corresponding database records of the advertisement listings, or in another suitable way.

The memorized response list is further used as a suggestion produced by the UFM suggestion generator (UFMSG 406, similar to the one discussed for the advertiser modes above) for another user with the similar entered keyword set. In such a combination, the user feedback listing suggestion mode (that is UFMSG 406) should preferably be tried first, since it may provide a faster finding.

If the item is not found, that is a user's test at (CA2) 402 is negative, then NCSG 407 (in the normalized category search suggestion mode) should be tried. SE 305 searches in the suggested normalized category, produces a result tested by the consumer at (CA3) 402. A positive test results in a transfer to EPF 403 and further to UFMM 404 (as described above); a negative test results in conditional ending at the end 405. Such a combined modes search is exemplified on FIGS. 12, 14, and further discussed below in more detail.

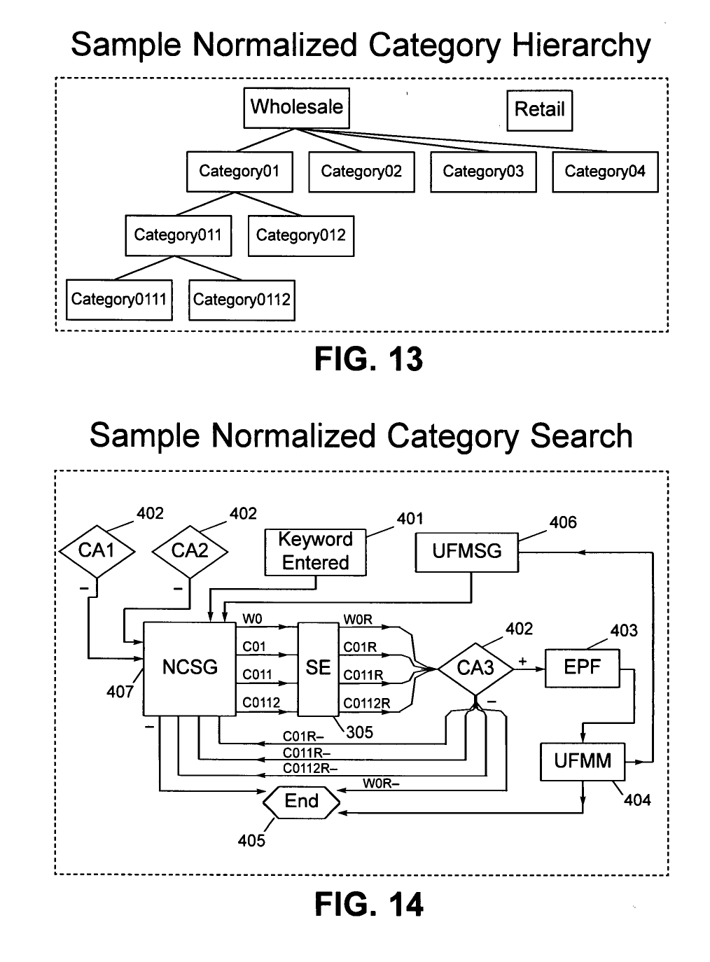

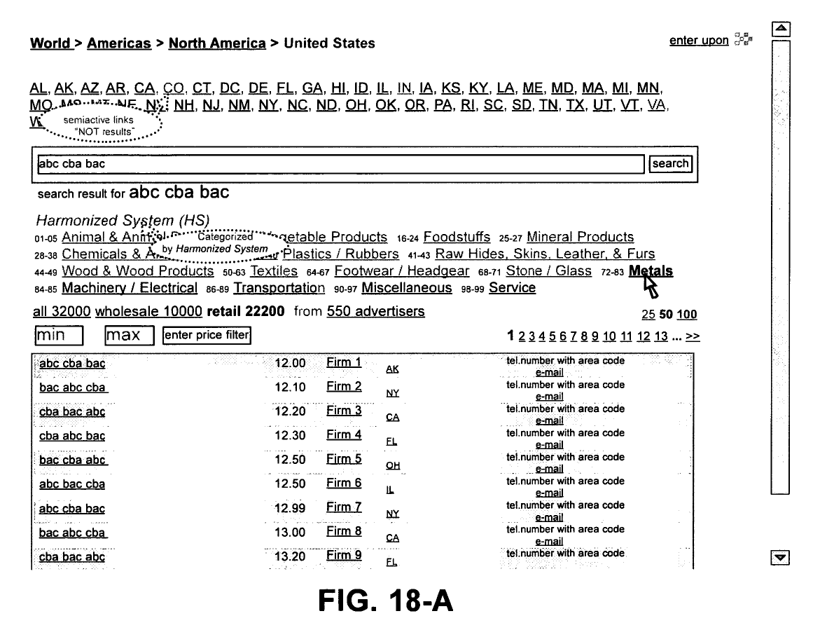

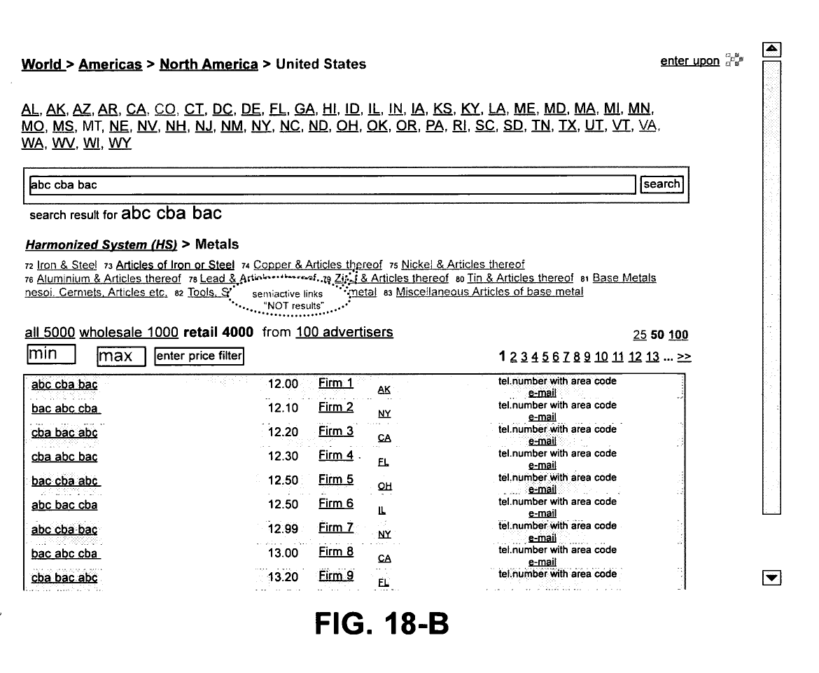

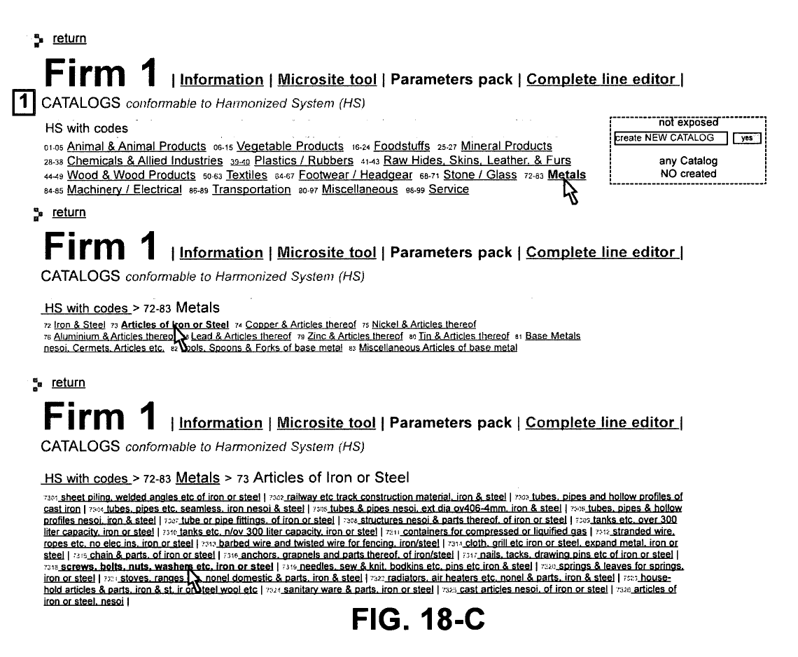

NCSG 407 should be implemented in conjunction with a normalized category hierarchy. Such a hierarchy can utilize, for instance, the Universal Harmonized System Codes or the like. An example of a normalized category hierarchy implementation is reflected on FIG. 13, discussed herein below. A normalized category hierarchy generally allows building more effective database structures and improving their performance comparatively to databases built on non-normalized categories. Sample GUIs for the NIDS deploying the Universal Harmonized System Codes are depicted on FIG. 18A, 18B, 18C, showing the selection of categories and search parameters.

FIG. 12 exemplifies a general structure and processing of a combined modes search for a consumer keyword request received by the NIDS in a preferred embodiment. This may be implemented as a portion of CLP 303 in conjunction with SE 305 (see FIG. 17) and other conventional modules and utilities (not illustrated).

On FIG. 13 most general “Wholesale” and “Retail” categories are positioned at the lowest (in terms of specialization) “zero” level. The first hierarchy lever, extended from only one general category “Wholesale”, consists of four Categories 01, 02, 03, and 04. The second level is extended from only one Category 01, and consists of two more specific Categories 011 and 012. The third level is extended from only one Category 011, and consists of two most specific Categories 0111 and 0112.

FIG. 14 illustrates a sample normalized category search structure and processing (as a part of the combined modes search reflected on FIG. 12) deployed for the exemplary normalized category hierarchy depicted on FIG. 13.

A user, searching for an item, enters keyterms into entered keyword block 401 (see also FIG. 12). The regular keyword search mode, conducted by SE 305, does not result in finding the item of interest (negative output from CA 1402 and CA2 402—FIGS. 12, 14). This further initiates UFMSG 406, a UFM suggested list of listings is generated, which also does not result in finding the item by the user, i.e. the CA2 402 test is negative that initiates NCSG 407, i.e. the normalized category suggestion mode begins.

NCSG 407 analyzes the entered keyterms obtained from keyword entered block 401 (FIGS. 12, 14), the UFM suggested listings for their preferable exclusion (not approved by the user) and generates a normalized category suggestion C0112 (the highest specialization level), shown on FIG. 14. SE 305 searches the entered keyterms in category C0112, resulted in obtaining a response list C0112R presented for user approval at CA3 402.

A positive CA3 test results in further registration by EPF 403 and memorizing by UFMM 404. A negative CA3 test results in generating a feedback signal C0112R— triggering NCSG 407 to generate a lower (less specialized) hierarchy level suggested category C011. SE 305 then searches in category C011, produces a response list C011R, tested by the user at CA3 402.

A positive CA3 test results in further registration by EPF 403 and memorizing by UFMM 404. A negative CA3 test results in generating a feedback signal C011R— triggering NCSG 407 to generate a lower hierarchy level suggested category C01. SE 305 then searches in category C01, produces a response list C01R, tested by the user at CA3 402.

A positive CA3 test results in further registration by EPF 403 and memorizing by UFMM 404. A negative CA3 test results in generating a feedback signal C01R— triggering NCSG 407 to generate a lowest specialization hierarchy level suggested category “Wholesale” W0. SE 305 then searches in category “Wholesale”, produces a response list W0R, tested by the user at CA3 402.

A positive CA3 test results in further registration by EPF 403 and memorizing by UFMM 404 and conditionally ending the program at end 405. A negative CA3 test results in generating a feedback signal W0R— and conditionally ending the program at end 405.

In some embodiments, the memorized category may further be used for a listing suggestion produced by UFMSG 406 for another user (consumer), which is conditionally shown by a dashed line on FIGS. 12, 14.

Basic Features and Steps of the Search Phase of Inventive Method

The inventive ad placement and search method further provides for a search of items by consumer users (a search phase), which items are expected to be described in the advertisement listings placed in the NIDS. The search phase includes a search request for a desirable item (or a collection of items), which request can be composed and submitted in a specified language from a preset list of languages, within specified geographical localities to be searched, within a specified price range, in a specified currency, etc. A specialized way and tools to compose and submit the search request for a multiple list of items can be provided in specific embodiments of the method.

As already mentioned, the search phase can be provided in different search modes (e.g. traditional keyword mode, user feedback listing suggestion mode, normalized category suggestion mode) selected by the consumer user, depending on his/her skills, facilitating the finding of the desired item. Some embodiments may propose the consumer user to elect the desirable mode from the very beginning of the search phase.

A response to the search can be produced in any desirable language from a predetermined list of languages and the response of the search includes found advertisement listings expected to substantially contain detail information on the item (collection of items) corresponding to the consumer's request, wherein the listings are preferably sorted and arranged by price, or otherwise if specified by the user.

In a preferred embodiment, the consumer user specifies the desirable language from a predetermined list of languages within specified geographical localities to be searched, within a specified price range, other desirable parameters or parameter ranges, and perhaps priced in a specified currency. The user enters a search request in the form of keywords composed in the specified language, which keywords, in the consumer's opinion, are best describing a desirable item to be searched. The NIDS will provide a traditional search in the keyword search mode.

In some instances, the response obtained from the NIDS will contain at least one ad listing, including information on the item, so that the consumer will be able to contact the corresponding advertiser(s), whose contact information was submitted and stored in the NIDS. Any response should question the user if he/she has actually found information pertaining to the desirable item, and possibly (in some embodiments) which specific listing(s) is found particularly useful. This may be performed, for example, by placing check boxes next to each listing in the response interface (not shown).

Thusly, if such information is found and the user provides the positive answer, the NIDS will check if there is a linkage of the requested keywords with the response listing(s) already stored in memory. If such linkage is not yet memorized in the system, it will store the entered keywords and link(s) to the respective listing(s) marked by the user, and will further suggest the listing(s) to other subsequent consumers who will have entered a similar keyword set.

In other instances, the user will not find such information in the response. It may happen, for example, if the entered keywords do not match the description of the item(s) provided by advertisers during the placement phase of the method. In such a situation, the consumer may give a negative answer (not satisfied with the response). The NIDS should propose her to switch to the user feedback listing suggestion mode (e.g. by questioning: “Do you want to see the listings of positive responses to previous requests similar to yours?”), and if consented, may propose her a suggestion of listing(s) linked to the keywords previously memorized by the system, similar to her entered keywords, as mentioned above. The proposed listing(s) should preferably exclude those already found by the consumer in the previous traditional keyword search mode.

The consumer considers the user feedback suggested listing(s). If she finds information on the desirable item, she may mark the particular listing(s) for further use by the NIDS for subsequent users, as discussed above. If however the NIDS does not have data records of listing(s) linked to similar keyword sets in memory, or the consumer is not satisfied with the user feedback suggested listing(s), the system may advise her to switch to the normalized category suggestion mode.

The NIDS analyzes the entered keywords, and generates a normalized category suggestion for the consumer. She then searches the suggested category and obtains a response list of ad listings for the category with a question of approval. The suggested listing(s) should preferably exclude those already found by the consumer in the previous traditional keyword search and user feedback suggestion modes. If she finds useful information pertaining to her entered keywords, she may approve a particular listing for further processing by the NIDS as explained above. If she doesn't find such information, she is proposed to search in a more generalized category (super-category). If accepted, in the super-category she gets a new response list and the process repeats until a certain scope of categories or the entire normalized category portion of the database will have been searched, or until the user abandons the search.

Different known semantic-aware and other approaches can be utilized for the analysis of keywords. For example, each normalized category may be assigned a list of descriptive words and associations with subcategories and super-categories. When the entered keywords match some of the descriptive words, a normalized category suggestion can be generated. Conventional XML methodologies and effective algorithms might be deployed for the analysis.

Each suggestion may include at least one category to search. The consumer may search each suggested category and is asked if such category has been useful. A positive answer is registered, checked if it's already memorized, and if not the entered keywords are saved with the corresponding link(s) to the respective listing(s).

The NIDS may additionally implement a statistics module (not illustrated), indicating the categories most frequently approved by consumers associated to particular entered keyterms. Such statistics module may be utilized in the user feedback suggestion mode and in the normalized category suggestion mode for both advertisers and consumers.

Examples of Client Advertiser and Client Consumer Interfaces

Client advertiser interface 106 and client consumer interface 105 (reflected on FIG. 1) are substantially sets of special GUIs designed to provide required functionality for interaction of the advertiser and the consumer with the NIDS. They may be implemented in variety of forms, some of which are exemplified herein below.

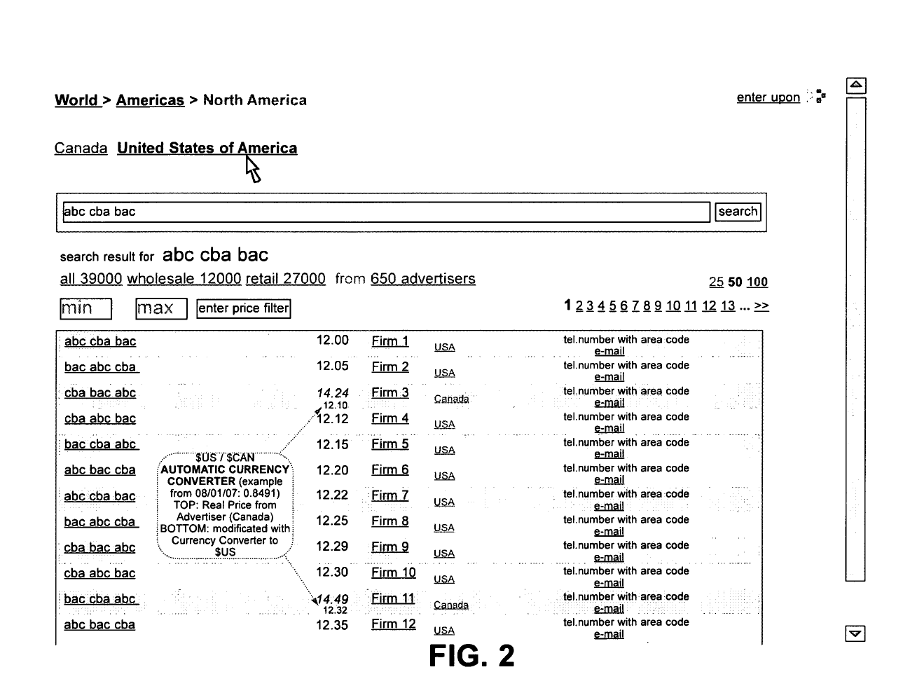

A client consumer GUI depicted on FIG. 2 shows a first page of a search response to the entered requested keywords: “abc cba bac” in the CGS position “World>Americas>North America”, which response consists of 650 advertisers listings. The GUI provides the user with two further choices: “Canada” and “United States of America”.

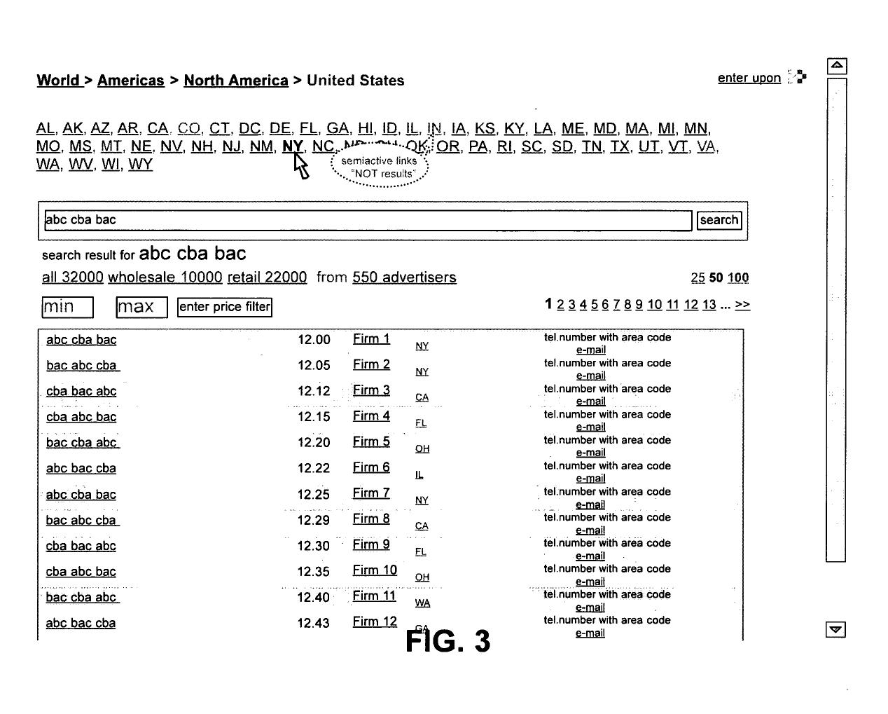

A client consumer GUI depicted on FIG. 3 shows a first page of a search response to the entered requested keywords: “abc cba bac” in the CGS position “World>Americas>North America>United States of America”, which response consists of 550 advertisers listings. The GUI provides the user with further choices of 50 states. Some of the states are highlighted in black (active, i.e. including ad listings) and the others are in gray (semi-active, i.e. have no listings at the moment).

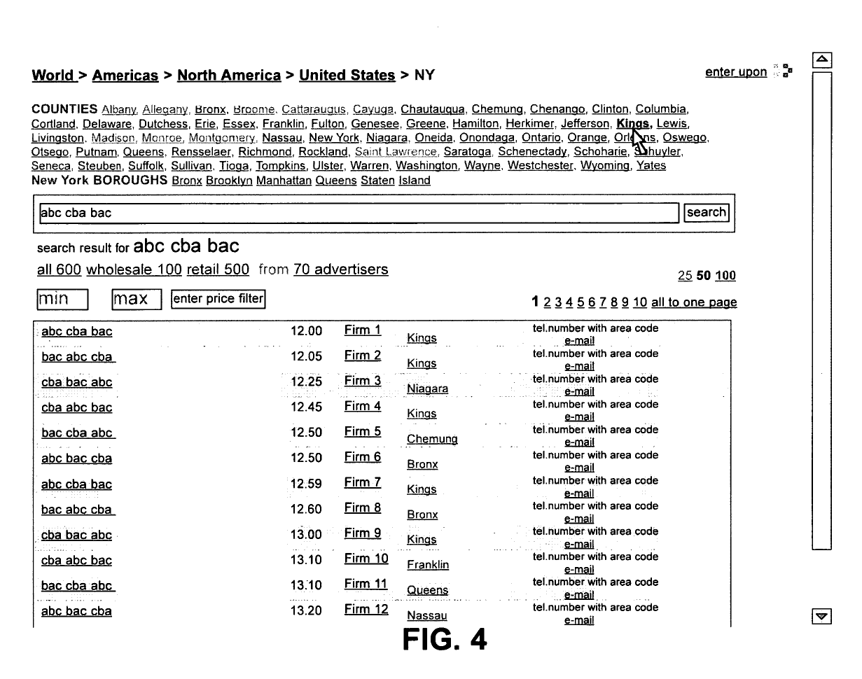

A client consumer GUI depicted on FIG. 4 shows a first page of a search response to the entered requested keywords: “abc cba bac” in the CGS position “World>Americas>North America>United States of America>NY”, which response consists of 70 advertisers listings. The GUI provides the user with further choices of counties of the State of New York. Some of the counties are highlighted in black (active, i.e. including ad listings) and the others are in gray (semi-active, i.e. have no listings at the moment).

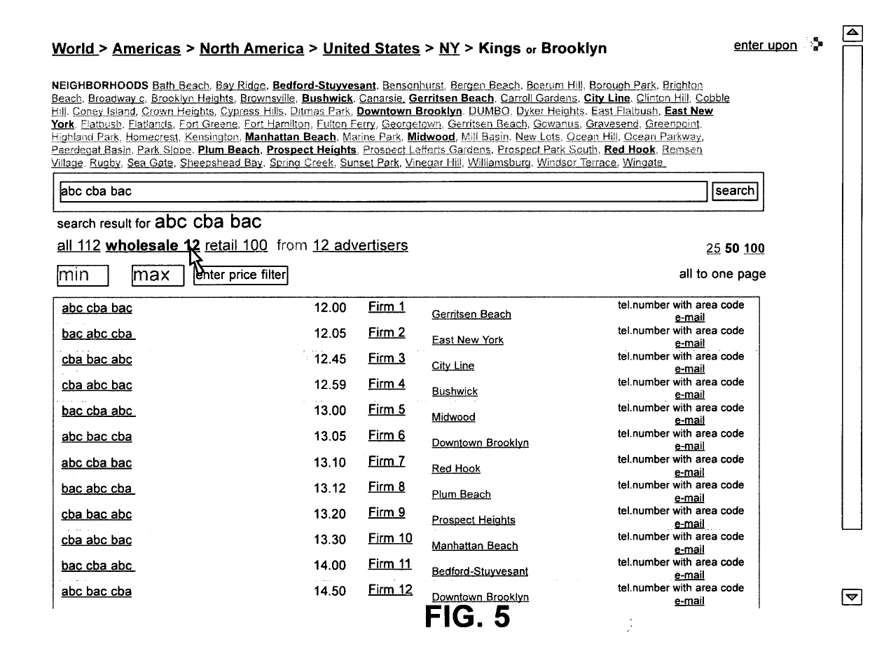

A client consumer GUI depicted on FIG. 5 shows a first page of a search response to the entered requested keywords: “abc cba bac” in the CGS position “World>Americas>North America>United States of America>NY>Kings or Brooklyn”, which response consists of 12 advertisers listings. The GUI provides the user with further choices of neighborhoods of the Kings County. Some of the neighborhoods are highlighted in black (active, i.e. including ad listings) and the others are in gray (semi-active, i.e. have no listings at the moment).

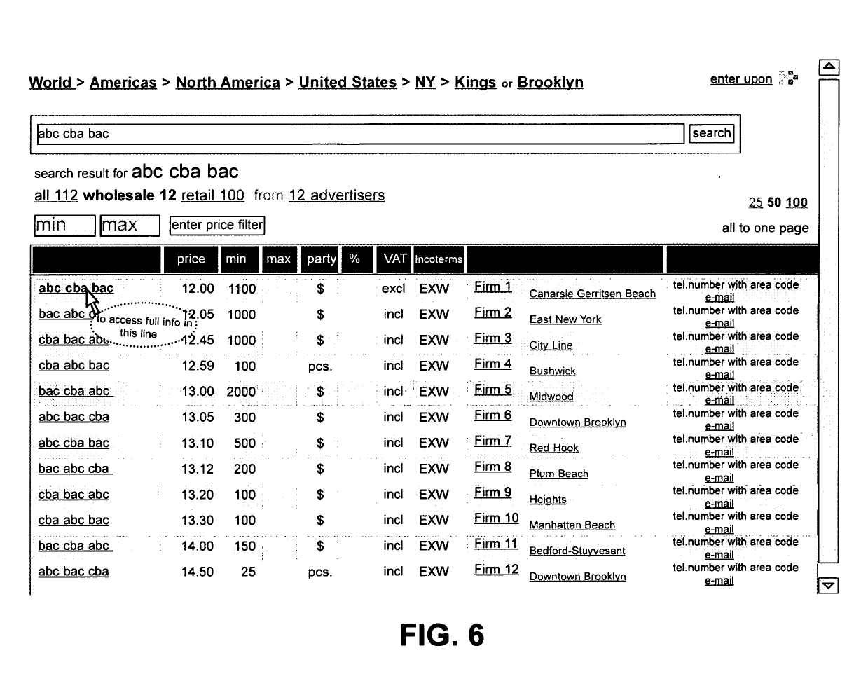

A client consumer GUI depicted on FIG. 6 shows the existing advertiser listings that are displayed to a user (consumer) in response to requested keywords: “abc cba bac” in the CGS position “World>Americas>North America>United States of America>NY>Kings or Brooklyn”, which response consists of 12 advertisers listings. The GUI provides the user with further choices of searching other keyword combinations, such as “bac abc cba”, and the like.

A client consumer GUI depicted on FIG. 7 shows the advertiser listing for “Firm 1” (which might be obtained by the user making the choice from the GUI on FIG. 6) that is displayed to the user (consumer) in response to requested keywords: “abc cba bac” in the CGS position “World>Americas>North America>United States of America>NY>Kings or Brooklyn”, which response provides the user with a brief description of the listed item corresponding to the requested keywords, an image of the item, brief information on Firm 1. The GUI provides the user with further choices of searching “Catalog retail” and “Catalog wholesale”, and other listings of “Category 2” of the “Catalog wholesale” (one of them can be seen for “abc bac cba” at the bottom of FIG. 7). The user can easily switch to any geographical layer of CGS by clicking a desirable link at the top of the page.

A client advertiser GUI depicted on FIG. 8 shows an advertiser listing entry form in the CGS position “World>Americas>North America>United States of America>NY>Kings or Brooklyn>Canarsie Gerritsen”, which form provides the advertiser with necessary and supplemental fields of data to be submitted to server advertiser program 108 (shown on FIG. 16).

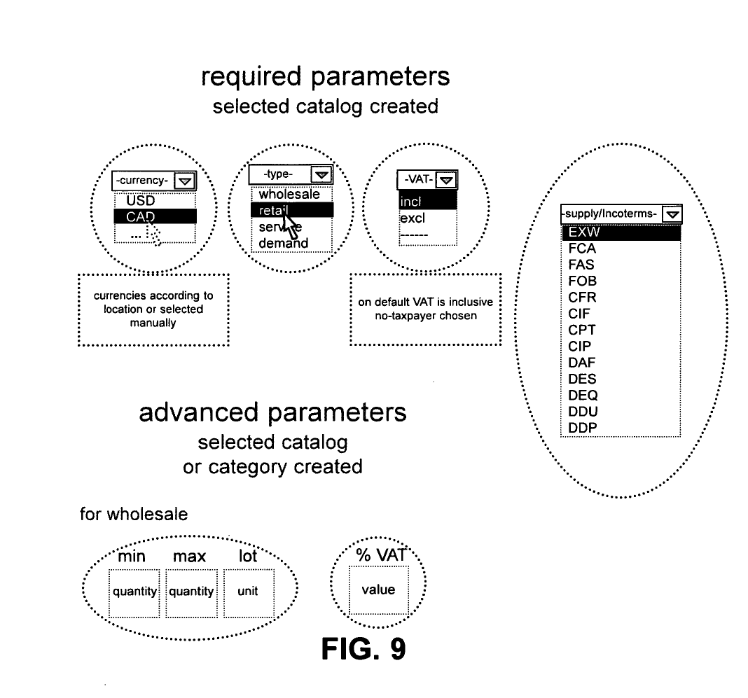

A client advertiser GUI depicted on FIG. 9 shows an advertiser listing entry form, which provides the advertiser with exemplary “required parameters” (generally selected while a catalog is being created, may be varied from country to country) and “advanced parameters” (generally selected while a catalog or a category is being created, may be varied) fields of data to be submitted to server advertiser program 108 (shown on FIG. 16). In this example, the GUI prompts the advertiser to indicate the currency in which his items are priced; the type (most general category) of listing (such as “wholesale”, “retail”—for goods; “service”—for services, “demand”—for items sought for purchase); value added tax requirement (VAT—included or excluded); Incoterms options; minimum quantity of a wholesale lot for sale, maximum quantity of a wholesale lot for sale; lot unit; percentage of VAT.

A client advertiser GUI depicted on FIG. 10 shows an advertiser listing entry form, which exemplarily provides the advertiser with means necessary to create a custom-made catalog or a category within a catalog, and set parameters for the catalog (category).

A client advertiser GUI depicted on FIG. 11 shows advertiser listing entry forms using a complete line editor and a parameter pack menus, which exemplarily provide the advertiser with means necessary to create a custom-made catalog or a category within a catalog, and set parameters for the catalog (category) for a plurality of items.

FIGS. 18A, 18B, 18C illustrate client advertiser GUIs showing a process of ad category creation and selection of listing parameters, which GUIs are implemented in conjunction with the Universal Harmonized System (HS).

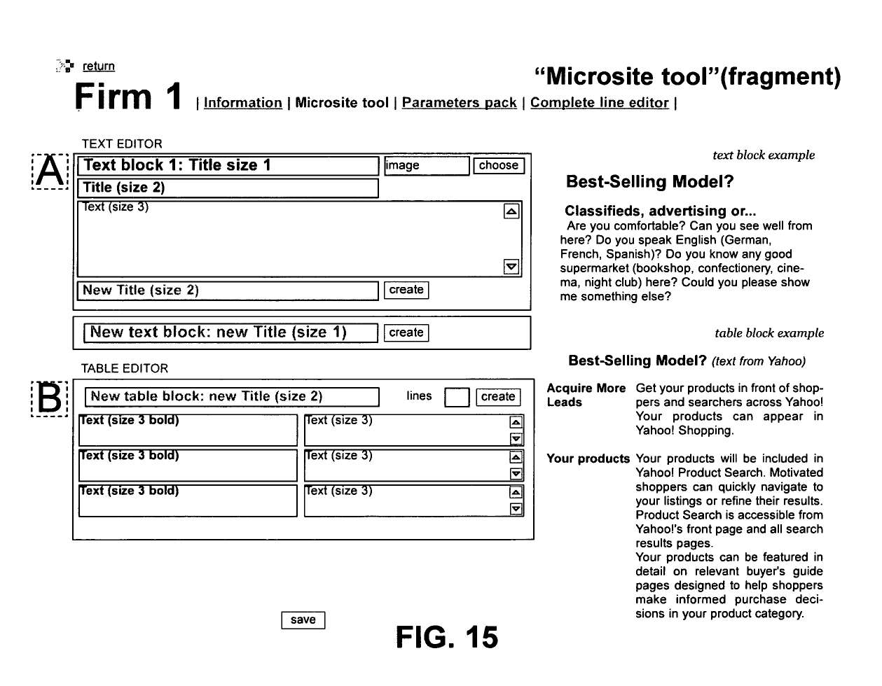

A client advertiser GUI depicted on FIG. 15 shows an advertiser listing entry form using a text editor for creation of microsites and placing references to other websites, discussed below.

Some embodiments may also include geographic map interfaces (not illustrated herein), and other conventionally known GUIs.

Optional Features of the Invention

Some embodiments of the NIDS may comprise a “microsite tool” that can create a “microsite” in an online mode. The microsite is a fragment of HTML code representing a portion of the NIDS' catalog, which may be inserted into the website of an advertiser. So that using the microsite tool, the advertiser may perform this task him/her self.

The microsite tool may also be used to accomplish the opposite task: create a microsite of the advertiser within the NIDS, that is the advertiser may have his/her own “online booth” in the system. Most of the existing online advertising mechanisms don't provide a permanent systematization and collection of data that characterized the advertiser, which can often be useful for consumers. Also, sometimes the advertisement service of an advertiser may be interrupted (his/her listing was not displayed in responses to users searches), for example, when the advertisement stops payments, etc. His/her microsite, however, remains in the NIDS. The microsite may also be used for backup purposes, if needed.

Advertisers of a particular NIDS may also use each other services and/or goods (items). An embodiment of the system may provide a tool (can be similar to the microsite tool) for placing references (recommendations) and links to other advertisers websites, or their microsites in the NIDS (see an example of such a reference in a “text block example” on FIG. 15). Similar recommendations may be obtained, for instance, from banks, major companies, etc., who previously served or used services of the advertiser, whose site the recommendation is placed on.

Some NIDS embodiments may comprise a module (RSS—not illustrated) notifying all registered advertisers about changes in the NIDS' database. It is also possible to provide registered consumers wishing to receive “news” about database updates or updates for a catalog of a particular advertiser(s) with such news, for example, regarding a particular product(s) they were looking for, but could not find.

There would be situations, when a consumer couldn't find a particular item(s) after completing a search even throughout the entire database. In such a case, it is probable that some of advertisers (sellers or producers) may have similar items, but not completely acceptable for the consumer. Then, it makes sense to place a consumer's collective request (CCR) to the advertisers tied to the database notifying of the need of the consumer and/or asking the advertisers to contact him/her in case they would be able to provide such a product. This also could be useful for handicapped people, experiencing difficulties with search or ordering, etc.

For implementation of a CCR module, some advertisers, who wish to participate in the CCR program, might specify a number of words coincided with a consumer request or other limitations, to receive the CCR. The CCR may contain information on a model, quality, quantity, conditions, prices, delivery terms, etc. It is useful for a consumer, looking for an opportunity to find necessary products, as well as for an advertiser, having a chance to follow new needs in the market.

Should the consumer finds necessary sellers/producers willing and able to provide the desirable product, a special product order module (not illustrated) may be implemented, including not only product description, price, delivery terms, but also payment options (such as letter-of-credit, seller's loan, etc.).

We claim:

1. A network information distribution system comprising:
server means for providing network server support;
database means for providing data storage and management, associated with the server means;
server advertising program means for providing functionality for placing at least one advertisement by advertiser users, said server advertising program means associated with the server means and the database means; and
server consumer program means for providing functionality for searching said at least one advertisement by consumer users, said server consumer program means associated with the server means and the database means.

2. The network information distribution system, according to claim 1, wherein
the database means including
a data structure based on a normalized category hierarchy;
the server advertising program means comprising a combination of two chosen from the following three:
(a) custom-made category creation means for enabling the advertiser users to create a custom-made category, or a custom-made catalog and a custom-made category within the catalog;
(b) means for resolution on a catalog or category within the catalog, responsive to an entry, related to said at least one advertisement, submitted by the advertiser users, said means for resolution including user feedback memory means for identifying the catalog or the category within the catalog, responsive to the entry, and, upon a user approval and finding no duplications, memorizing the category, the entry, and a link therebetween, said memorized category, entry, and link capable to be used for suggesting the category to subsequent users submitting a similar entry; and
(c) means for resolution on the normalized category hierarchy responsive to an entry, related to said at least one advertisement, submitted by the advertiser users, said means for resolution including normalized category suggestion generating means for generating a suggestion for the advertiser users on a category within the category hierarchy responsive to the entry.

3. The network information distribution system, according to claim 1, wherein
the database means including
a data structure based on a normalized category hierarchy;
the server advertising program means comprising:
(a) custom-made category creation means for enabling the advertiser users to create a custom-made category, or a custom-made catalog and a custom-made category within the catalog;
(b) means for resolution on a catalog or category within the catalog, responsive to an entry, related to said at least one advertisement, submitted by the advertiser users, said means for resolution including user feedback memory means for identifying the catalog or the category within the catalog, responsive to the entry, and, upon a user approval and finding no duplications, memorizing the category, the entry, and a link therebetween, said memorized category, entry, and link capable to be used for suggesting the category to subsequent users submitting a similar entry; and
(c) means for resolution on the normalized category hierarchy responsive to an entry, related to said at least one advertisement, submitted by the advertiser users, said means for resolution including normalized category suggestion generating means capable to generate a suggestion for the advertiser users on a category within the category hierarchy responsive to the entry.

4. The network information distribution system, according to claim 1, wherein
the server advertising program means comprising:
custom-made category creation means for enabling the advertiser users to create a custom-made category, or a custom-made catalog and a custom-made category within the catalog.

5. The network information distribution system, according to claim 1, wherein
the server advertising program means comprising:
means for resolution on a catalog or category within the catalog, responsive to an entry, related to said at least one advertisement submitted by the advertiser users, said means for resolution including user feedback memory suggestion means for identifying the catalog or the category within the catalog, responsive to the entry, and, upon a user approval and finding no duplications, memorizing the category, the entry, and a link therebetween, said memorized category, entry, and link capable to be used for suggesting the category to subsequent users submitting a similar entry.

6. The network information distribution system, according to claim 1, wherein
the database means including
a data structure based on a normalized category hierarchy; and
the server advertising program means comprising:
means for resolution on the normalized category hierarchy responsive to an entry related to said at least one advertisement, submitted by the advertiser users, said means for resolution including normalized category suggestion generating means for generating a suggestion for the advertiser users on a category within the category hierarchy, responsive to the entry.

7. The network information distribution system according to claim 1, wherein
the server advertising program means comprising:
means for multi-language processing.

8. The network information distribution system according to claim 1, wherein
the server advertising program means comprising:
means for national currencies conversion information.

9. The network information distribution system according to claim 1, wherein
the server advertising program means comprising:
means for multiple items entry.

10. The network information distribution system according to claim 1, wherein
the server advertising program means comprising:
means for geographical locality resolution;
means for multi-language processing;
means for national currencies conversion information; and
means for multiple items entry.

11. The network information distribution system according to claim 1, wherein
the server consumer program means comprising:
a search engine configured to provide at least a keyword search.

12. The network information distribution system according to claim 11, wherein
the server consumer program means further comprising:
feedback memory suggestion means responsive to a keyterms entry, related to at least one item being searched by the consumer users, said feedback memory suggestion means including feedback suggestion generating means for generating a suggestion for the consumer users in the form of a list of advertising listings earlier approved by previous users entered similar keyterms.

13. The network information distribution system according to claim 11, wherein
the database means including
a data structure based on a normalized category hierarchy; and
the server consumer program means further comprising:
means for resolution on the normalized category hierarchy responsive to a keyterms entry, related to at least one item being searched by the consumer users, said means for resolution including normalized category suggestion generating means for generating a suggestion for the consumer users on a category within the normalized category hierarchy, responsive to the entry.

14. The network information distribution system according to claim 11, wherein
the database means including
a data structure based on a normalized category hierarchy;
the server consumer program means further comprising:
(a) means for resolution on the normalized category hierarchy responsive to a keyterms entry, related to at least one item being searched by the consumer users, said means for resolution including normalized category suggestion generating means for generating a suggestion for the consumer users on a category, within the normalized category hierarchy, responsive to the entry; and
(b) feedback memory suggestion means responsive to a keyterms entry, related to at least one item being searched by the consumer users, said feedback memory suggestion means including feedback suggestion generating means for generating a suggestion for the consumer users in the form of a list of advertising listings earlier approved by previous users entered similar keyterms.

15. The network information distribution system according to claim 1, wherein
the server consumer program means comprising:
means for multi-language processing.

16. The network information distribution system according to claim 1, wherein
the server consumer program means comprising:
means for national currencies conversion information.

17. The network information distribution system according to claim 1, wherein
the server consumer program means comprising:
means for multiple items entry.

18. The network information distribution system according to claim 1, wherein
the server consumer program means comprising:
means for geographical locality resolution;
means for multi-language processing;
means for national currencies conversion information; and
means for multiple items entry.

19. A computer implemented method of advertising and search for supply and demand of products/goods/services in any geographical location comprising the acts of:
a) providing network information distribution system means for placement of at least one advertisement listing, including information on at least one item, into the system means by an advertiser and search for at least one desirable item in the system means by a consumer;
b) placement of said at least one advertisement listing into the system means;
c) search for at least one desirable item in the system means;
d) obtaining a response from the system means, said response capable to be produced as a result wherein the result being positive when said response including at least one of the listings, or the result being negative when said response including no listings; if said result being positive going to act (e), otherwise going to act (e2);
e) evaluating the response;
e1) if said response including information pertaining to said at least one desirable item, enabling the consumer to contact the advertiser who placed the listing containing said pertaining information, otherwise going to act (e2);
e2) if a predetermined scope of said at least one advertisement listing has been searched, ending the method, otherwise going to act (e3);
e3) if the predetermined scope of said at least one advertisement listing has not been searched, repeating act (c).

20. The method according to claim 19, wherein act (b) comprising:
specifying a language chosen from a predetermined list of languages; composing said at least one advertisement listing in the specified language; and
submitting said at least one advertisement listing in the specified language to the system means.

21. The method according to claim 19, wherein act (b) comprising:
composing said at least one advertisement listing to include multiple items; and
submitting said at least one advertisement listing to the system means.

22. The method according to claim 19, wherein act (b) comprising the acts of:
(b1) conducting act (b) in a normalized category suggestion mode;
(b11) if the system means capable to provide a suggestion for a catalog, a category of the catalog for placement of said at least one advertisement listing, going to act (b12), otherwise going to act (b2);
(b12) obtaining a catalog and a category of the catalog for placement of said at least one advertisement listing;
(b13) setting the catalog, category, geographical location, and predetermined parameters describing said at least one item in said at least one advertisement listing; and
(b14) submitting said at least one advertisement listing to the system means, quitting act (b);
(b2) conducting act (b) in a user feedback category suggestion mode;
(b21) if the system means capable to provide a suggestion for a catalog, a category of the catalog for placement of said at least one advertisement listing, going to act (b12), otherwise going to act (b3);
(b3) conducting act (b) in a custom-made category creation mode, going to act (b12).

24. The method according to claim 19, wherein
act (b) conducted subsequently in a combination of two modes chosen from the following three modes:
a normalized category suggestion mode;
a user feedback category suggestion mode; and
a custom-made category creation mode.

25. The method according to claim 19, wherein
act (c) conducted in a regular keyword search mode, going to act (d);
if said result of act (d) being positive going to act (e), otherwise switching to a user feedback listing suggestion mode;
act (c) conducted in the user feedback listing suggestion mode, going to act (d);
if said result of act (d) being positive going to act (e), otherwise switching to a normalized category suggestion mode; and
act (c) conducted in the normalized category suggestion mode, going to act (d);
if said result of act (d) being positive going to act (e), otherwise going to act (e2).

26. The method according to claim 19, wherein
act (c) conducted subsequently in a combination of two modes chosen from the following three modes:
a normalized category suggestion mode;
a user feedback listing suggestion mode; and
a regular keyword search mode.

27. The method according to claim 19, wherein act (c) comprising:
composing a request to search for multiple items; and
submitting said request to the system means.

28. The method according to claim 19, wherein
said response including said at least one advertisement listing containing a plurality of advertisement listings sorted and arranged by price.

29. The method according to claim 19, wherein
act (c) comprising:
composing a request for search in any desirable language from a predetermined list of languages;
submitting said request to the system means; and
said response of act (d) produced in any desirable language from a predetermined list of languages.
